(19) United States
(12) Patent Application Publication
(10) Pub. No.: US 2009/0288353 A1
(43) Pub. Date: Nov. 26, 2009

(54) Screen for glazed areas

(76) Inventors: Colin Stewart Barsby, Ferntree Gully (AU); Machour Dleikan, Ferntree Gully (AU)

Correspondence Address: JACOBSON & JOHNSON, ONE WEST WATER STREET, SUITE 285, ST. PAUL, MN, 55107, US

(21) Appl. No.: 12/454,176

(22) Filed: May 13, 2009

(30) Foreign Application Priority Data
May 13, 2008 (AU) 2008902335

(51) Int. Cl. E06B 3/26; B23P 11/00

(52) U.S. Cl. 52/202; 29/897.32

(57) ABSTRACT

A screen for a glazed area such as a window or a door to reduce heat transfer has a board with a light reflective face and top and bottom tracks to permit attachment to the wall around a window or door opening. In a variant a transparent fluted plastic board has frame extrusions on the top and bottom edge to close the flutes and is supported in top and bottom tracks enabling the assembly to be lifted in and out and slid laterally. This variant can be installed in a window opening and exerts a double glazing and noise reduction effect.

### FIELD OF THE INVENTION

This invention concerns screens for glazed areas in buildings.

### BACKGROUND OF THE INVENTION

All windows and glazed doors allow solar heat and light into the building interior. If householders fail to limit such solar exposure, the heat gain soon becomes uncomfortable especially in north and west aspects. Likewise in cold weather the building loses heat steadily through the glazed areas and into the roof space.

Drapes are poor interceptors and internal blinds, though somewhat better, allow considerable air movement and light leakage. External blinds are more effective but are also more costly and may prevent escape from a building in the event of fire.

### SUMMARY OF THE INVENTION

The first apparatus aspect of the invention provides a panel for covering a glazed area in order to modify the transfer of heat and light temporarily, comprising a screen made of fluted plastic board capable of reducing the transmission of light, having a top and bottom edge and separate channel supports attachable to the glazed areas for receiving the top and bottom edges, whereby the screen can be lifted in and lifted out as required.

The second apparatus aspect of the invention provides a screen made of fluted plastic board wherein the open ends of the flutes are sealed.

A single board of 3-10 mm thickness suffices to block light or reflect solar heat using a silver grey coating.

The screen may comprise a pair of boards arranged face to face. Such boards may be 2-3 mm thick, making the composite screen 4-6 mm thick. Two or more boards may be placed face to face for thermal insulation. Multi-wall boards about 32 mm thick may be used for acoustic insulation, preferably in double thickness.

Alternatively the screen may be a different standard thickness of fluted board, preferably 10 mm. Thickness of this range ensures a screen which is easy to lift into position.

In all embodiments of the screen, it is preferable to reduce convection flow as the screens heat up by closing the ends of the flutes with sealing means. The sealing means may be adhesive tape. This may lie along the top and bottom edges preventing the flutes acting as thermal chimneys. The sealing means may instead be a channel section resilient extrusion which can be sprung over the edge and left in position to grip the edge permanently. This has the advantage of hiding the adhesive tape if the two means are used together.

The channel supports may be equal in length to the top and bottom edge of the screen. Their purpose is to remain permanently attached to the window frame or the wall surrounding the glazed area.

The supports may be aluminium extrusions. The channels may have one of their faces treated to improve adhesion to a double sided adhesive tape. Alternatively the channels may be of asymmetric section, one wall being higher than the other to allow screw fixing.

The flute board may be made of pigmented polymer such as polypropylene. This will act to block 100% of incident light. This is useful for excluding all light from a bedroom window to allow sleepers to sleep into daylight hours and to exclude streetlight in cities.

If the purpose of the screen is to merely reduce glare, the screen material may be translucent or transparent.

Screens for larger glazed areas, such as ranch slider doors, may require two sheets of fluted board to be joined. H-section joiners are suitable.

### BRIEF DESCRIPTION OF THE DRAWINGS

Embodiments of the invention are now described by way of example with reference to the accompanying drawings, in which: —

FIG. 1 is an exploded perspective.

FIG. 2 is a section of a solar reduction screen.

FIG. 3 is an exploded view of the solar reduction screen of FIG. 2.

FIG. 4 is an exploded view of the double glazing panel.

FIG. 5 is a view of the window from the room interior.

FIG. 6 is a section of the arrangement of FIG. 5.

FIG. 7 is an exploded view of a double glazing panel with L-shaped corner brackets.

### DETAILED DESCRIPTION WITH RESPECT TO THE DRAWINGS

### Flush Wall Fitting

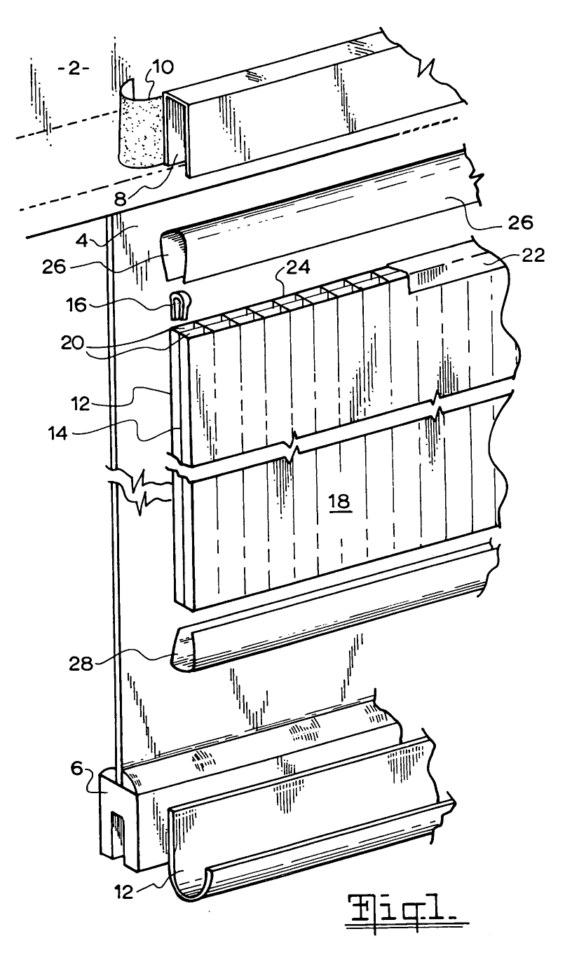

Referring firstly to FIG. 1, a wall surface 2 surrounds glass 4 in a metal window frame 6. An inverted aluminium channel 8 is adhered to the wall surface using double sided tape 10. A corresponding J-section asymmetric extrusion 12 is adhered to the wall somewhat lower than the bottom edge of frame 6 in like manner. Accordingly this version remains surface mounted outside the window opening but inside the room.

The screen consists of a front sheet 12 of fluted board 3 mm thick and a rear sheet 14 of the same material, both made of plastic available under the trade marks CORFLUTE and FLUTEBOARD.

The sheets are pinned face to face by spring clips 16. The exposed face of the front sheet is covered by a sheet of solar reflective film (not shown). The exposed face 18 of the rear sheet is painted a decor colour to suit the room. The flutes 20 in both sheets run vertically and are closed by a strip of adhesive tape 22 which stops the flutes sending solar heat into the room and prevents the ingress of egg-laying insects.

The top edge 24 of the paired sheets are gripped by a half round plastic cap extrusion with tapered legs 26. The bottom edge is inserted into a like cap extrusion 28.

The sheet length and width is selected so as to fit between channel 8 and extrusion 12 in a lift and drop fashion. Thus the screen sits close to the glass 4 and very close to the wall 2 surrounding the glass. This confines any heated air between the glass and the solar reflective layer of the screen. At night the warm air in the room is restricted in its contact with the cold glass and condensation is reduced.

If a large area such as a ranch slider door is to be screened, the length may exceed the available sheet length. Two sheets may be joined edge to edge by a H-section joiner which still permits the top and bottom edges to be protected by the cap extrusions. Single sheet versions with fluted board made of polycarbonate allows almost unchanged light transmission but affords insulation to prevent condensation. The version shown in FIG. 1 is attached to a glazed door and to the static half of a ranch slider.

Within Window Fitting

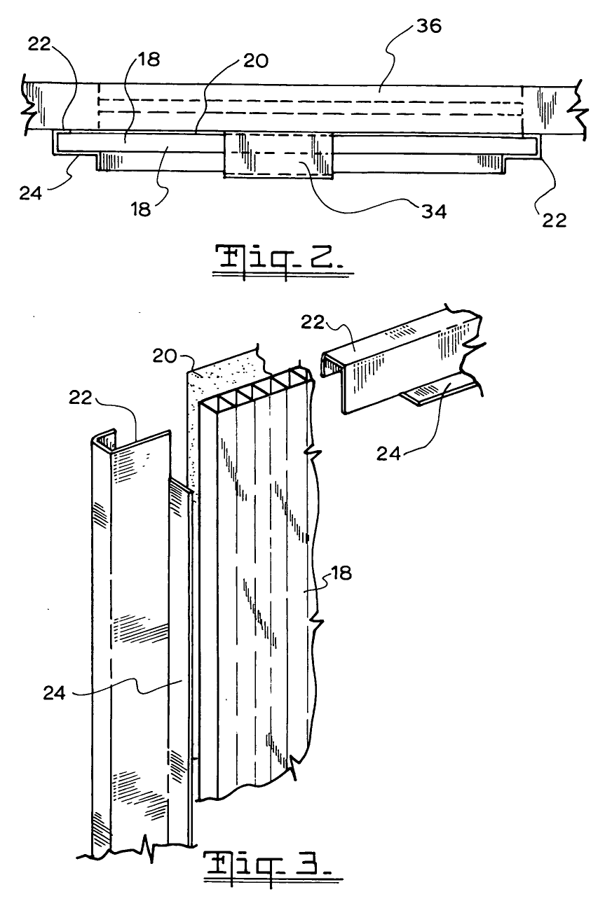

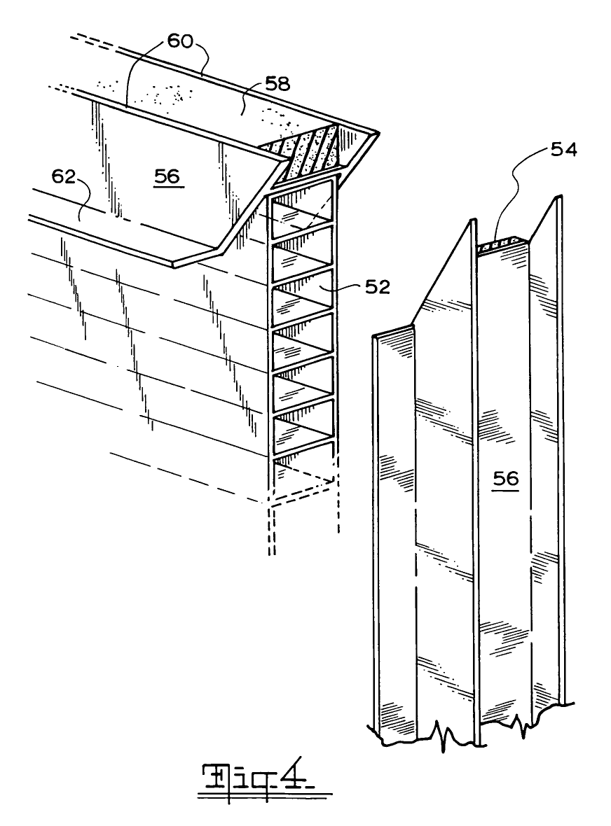

FIGS. 2 and 3 show the construction of a solar screen consisting of a single 3 mm rectangular panel of fluted plastic board 18 to which a front sheet of aluminium foil 20 is adhered. The panel has extruded PVC caps 22 adhered to all four edges. The extrusions have a flange 24. The extrusions mutually overlap at the four corners. Such solar screens are lightweight and are held in place by 100 mm lengths of channel section track 34 fixed to the header 36 by double sided adhesive tape. A short length of track is sufficient to keep the screen in place and if a window is shaded by two side by side screens, one may be parked behind the other to allow the occupant of the room to see through the window if required.

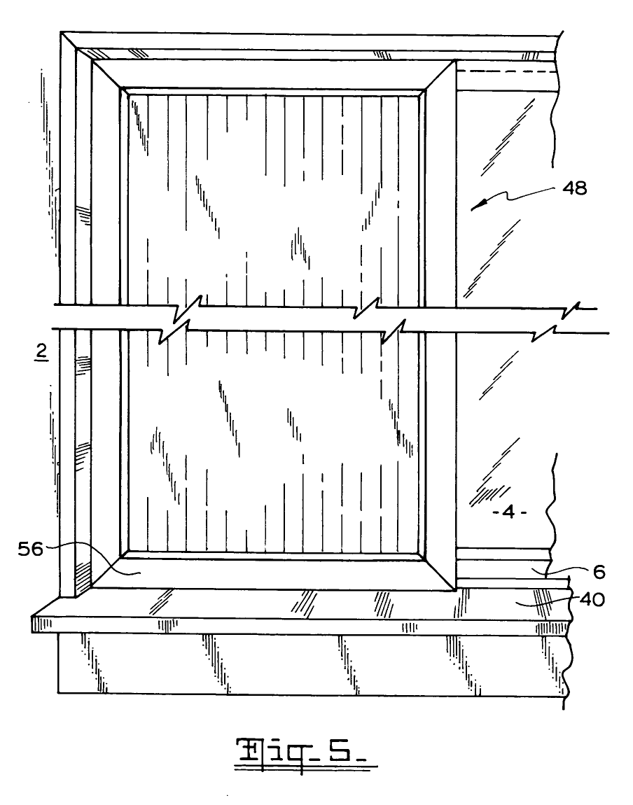

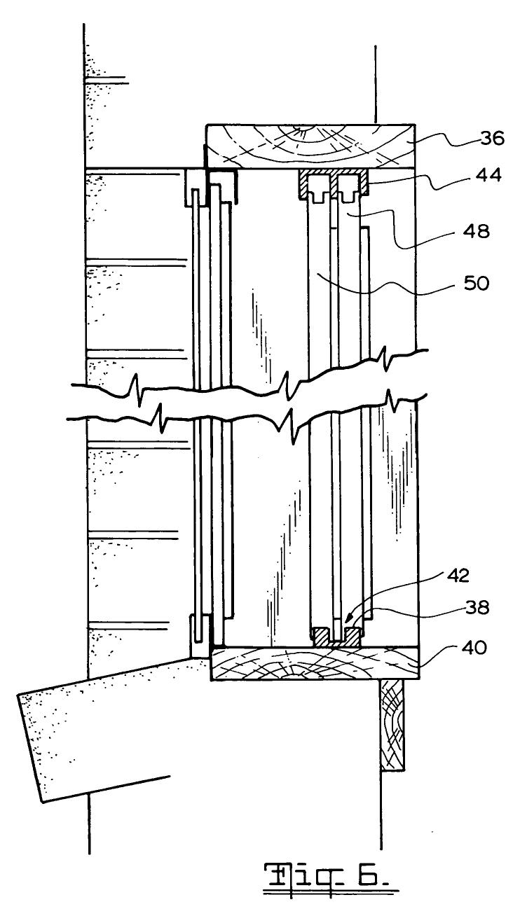

Referring now to FIGS. 4-6, the window to receive the glazing assembly is prepared by fixing extruded track 38 to the window board 40, 100 mm from the window frame. The track extends from side to side, that is the full width of the window opening. This track has a central groove 42. A deep track 44 is fixed to the header 36. The upstands 46 of the wider track 44 overlie track 38 in order to permit the glazing panels 48, 50 to slide easily.

The dimensions for the pair of glazing panels are now taken from the window opening and a sheet of 10 mm thick fluted plastic board MAKROLON® is cut to size, and sawn again into two panels such that the flutes 52 stand vertically. The open ends of the flutes are sealed with a thin foam strip 54 and cap extrusions 56 are mitred to surround each of the two panels. A thicker strip of plastic foam 58 is seated between the walls 60 of the extrusion. One of the walls has a flange 10 mm deep 62 which forms a continuous projection around the frame in the finished panel. The panels are next lifted and dropped into the top and bottom tracks so that they occupy the entire window opening and the flanges 62 of both panels face the interior of the room.

The strip of plastic foam 58 is adhered to the frame members forming the vertical sides of the finished panels. The foam is about the same thickness as the cap of the extrusion and is intended to seal the finished panel to the upright walls of the window opening.

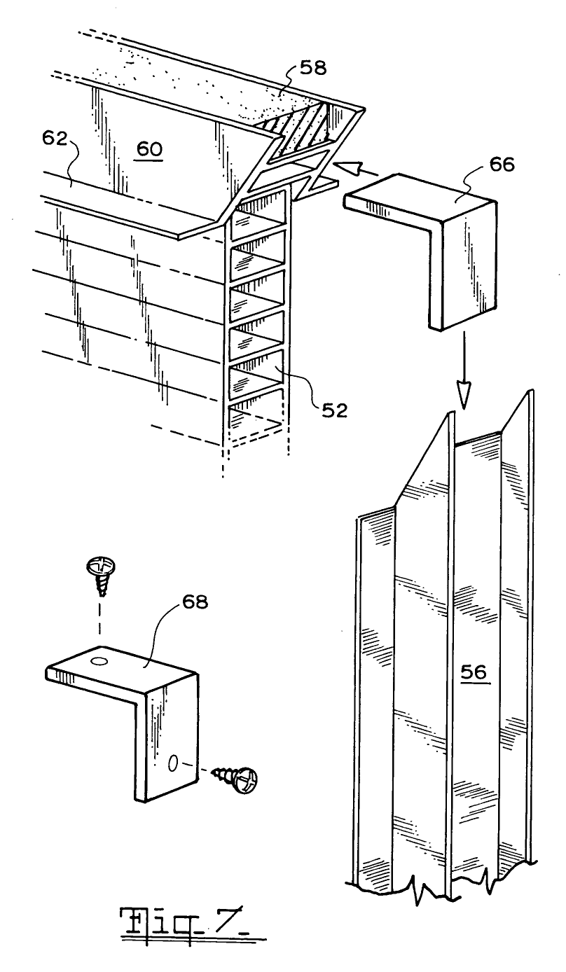

FIG. 6 shows the approximate spacing of the solar screen and 10 mm thick transparent panels. As the panels lie side by side one can be parked behind the other to give clear vision through the permanent glass to check the exterior of the building.

FIG. 7 shows a variant with a continuous compartment 64 in the extrusion for the reception of an L-shaped, steel corner stiffener 66. The panels 48, 50 may instead have external steel corner stiffeners 68 held in place by screws.

Front sheet 12 is as described in the above embodiment with plastic cap extrusions. Screen 18 rides in plastic channel extrusions adhered to boards 30 top and bottom by double sided adhesive tape 32 (see FIG. 3). As sheet 12 is light weight the channel may not be continuous but installed in 100 mm lengths as shown. In a non-illustrated variant here are side by side channels and a pair of sheets enabling one to be parked behind the other.

In use these components would be available as a kit and the panels sold with the extrusions necessary to install them as shown in FIGS. 2 and 4 in standard sizes, 600×900 mm, 900×1200 mm, 900×1800 mm and 1000×2100 mm. The most suitable sheet is selected and cut to size if necessary. Adhesive tape is cut from a roll and the tracks are cut to the correct size. Heat gain and loss through glazed areas is in this way controlled.

The flutes in the glazing panels distort the view of the outside somewhat but if clear version is required, for example to read a vehicle registration number, the occupant need only slide one panel behind the other to restore the original view.

Commercial premises with perhaps larger area of glass utilise the same procedure but require thicker stiffer panels. Handles and knobs fixed to the panel make their movement easier.

We have found the advantages of the above embodiment to be:

1. The opacity and reflectivity of the solar reflector panel is high with consequent reduction in heat gain during the day.

2. The fluted plastic panel exerts a double glazing effect minimising heat loss at night and reducing condensation.

3. The 100 mm space between the glass and the fluted panel provides noise reduction.

4. All the panels are lightweight and are easily lifted in and out of the tracks. No extra glass is needed.

5. The screens are significantly lower in costs than other forms of insulation for glazed areas.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

What is claimed is:

1. A method of making a double glazing assembly, comprising application to the edges of a panel of transparent, plastic, fluted board of the required size, a first frame member to cover the open ends of the flutes along one edge and a second frame member to close the flutes along the opposite edge.

2. A method as claimed in claim 1, wherein third and fourth framing members are applied to the remaining edges of the panel to make a closed frame.

3. A method as claimed in claim 2, wherein at least one of the framing members has a projecting surface accessible to the operator for allowing the panel to be slid manually when installed as part of a double glaze system.

4. A method as claimed in claim 1, wherein the frame members are cap extrusions.

5. A method as claimed in claims 1, wherein the open ends are additionally closed by sealing with adhesive tape.

6. A method as claimed in claim 2, wherein the frame members have mitred corners.

7. A method as claimed in claim 2, wherein the frame members are mutually overlapped at the corners.

8. A kit of parts for a glazing accessory which modifies heat transfer through the windows of a building consisting of a sheet of transparent, fluted plastic board, lengths of extruded channel members divisible into tracks, and lengths of cap extrusions, divisible into frame pieces for the sheet.

9. A kit of parts for a solar screen which modify solar transmission through the window of a building consisting of a sheet of opaque material rendered light reflective on one face, lengths of cap extrusions divisible into frame pieces for the opaque sheets, a length of extruded channel operable to receive and retain one or more edges of the sheets.

10. A glazing assembly for covering at least part of a glazed area in a building, comprising a removable transparent thermal barrier for the glazed area, having a lightweight, multi-wall panel with frame members attached to at least the top and bottom edges of the panel, and separate channel tracks attachable to the window opening for receiving the top and bottom edges of the panel, whereby the board can be lifted in and out as required.

11. A panel for covering at least part of a glazed area in a building, comprising a removably light barrier assembly for the glazed area of a building, comprising a lightweight panel with a light reflective face, frame members attached to at least the top and bottom edges and a channel member which is attachable to the window opening so as to project downwardly from the top edge of the glazed area and is capable of receiving the top edge frame member of the panel.

12. A glazing assembly as claimed in claim 10, wherein the separate channel tracks define side by side paths for the frame members allowing one panel to be slid laterally to lie behind the other.
